(19) United States
(12) Patent Application Publication
(10) Pub. No.: US 2017/0046261 A1
(43) Pub. Date: Feb. 16, 2017

(54) STORAGE DEVICE AND METHOD FOR SAVING WRITE CACHE DATA

(71) Applicant: Kabushiki Kaisha Toshiba, Tokyo (JP)

(72) Inventors: Michihiko Umeda, Yokohama Kanagawa (JP); Yusuke Izumizawa, Yokohama Kanagawa (JP); Nobuhiro Sugawara, Yokohama Kanagawa (JP); Seiji Toda, Kawasaki Kanagawa (JP)

(21) Appl. No.: 14/965,861

(22) Filed: Dec. 10, 2015

Related U.S. Application Data
(60) Provisional application No. 62/205,029, filed on Aug. 14, 2015.

(51) Int. Cl. G06F 12/08; G06F 3/06

(52) U.S. Cl. CPC G06F 12/0804; G06F 3/0611; G06F 3/0619; G06F 3/0659; G06F 3/068; G06F 12/0848; G06F 2212/1024; G06F 2212/1032; G06F 2212/284; G06F 2212/3042; G06F 2212/305; G06F 2212/401; G06F 2212/601

(57) ABSTRACT

According to one embodiment, a storage device includes a nonvolatile storage medium, a volatile memory and a controller. The volatile memory includes a cache area and a cache management area. The cache area is used to store, as write cache data, write data to be written to a user data area of the nonvolatile storage medium. The cache management area is used to store management information associated with the write cache data and including a compression size for the write cache data. The compression size is calculated in accordance with reception of a write command. The controller compresses, based on the management information, write cache data which is not saved to a save area and is needed to be compressed, and writes the compressed write cache data to the save area.

### CROSS-REFERENCE TO RELATED APPLICATIONS

This application claims the benefit of U.S. Provisional Application No. 62/205,029, filed Aug. 14, 2015, the entire contents of which are incorporated herein by reference.

### FIELD

Embodiments described herein relate generally to a storage device and a method for saving write cache data.

### BACKGROUND

Recent storage devices, for example, magnetic disk devices are generally include a cache for increasing access speed by a host system (host). The cache is used to store data (write data) specified by a write command from the host, and data read from a disk in accordance with a read command from the host.

In general, the cache is realized using a volatile memory. Accordingly, write data (namely, write cache data) stored in the cache is lost due to power interruption of the supply of power to the magnetic disk device.

In order to avoid loss of write cache data due to the power interruption, namely, in order to protect write cache data from the power interruption, various methods have been proposed. First and second methods described below are known as representative methods.

The first method is one in which a backup power supply is used during the power interruption to save write cache data from the cache to a nonvolatile memory, such as a flash ROM. A write-cache-data protection function provided by the first method is also called a power loss protection function.

The second method is one in which when write data specified by a write command is received, write cache data is saved from the cache to a particular area (save area) on a disk (disk medium) under a certain condition. A write-cache-data protection function provided by the second method is also called a media cache function.

In the application of the power loss protection function, write cache data is saved to the nonvolatile memory using the backup power supply. Accordingly, the amount of write data that can be cached is determined by period. (namely, a backup possible period) during which the supply of power from the backup power supply is possible, and by speed of writing data to the nonvolatile memory. In the application of the media cache function, latency inevitably occurs until write cache data is saved to the save area of the disk. Therefore, there is a request for reducing the time required for the write cache data to be saved. At least the power loss protection function or the media cache function can be also provided by a storage device other than the magnetic disk device, such as a solid-state drive (SSD).

### BRIEF DESCRIPTION OF THE DRAWINGS

FIG. 1 is a block diagram showing an exemplary configuration of a magnetic disk device according to an embodiment.

FIG. 2 is a view showing a data structure example of a cache management table shown in FIG. 1.

FIG. 3 is a flowchart showing an exemplary procedure of write-data reception processing in the embodiment.

FIG. 4 is a flowchart showing an exemplary procedure of write-back processing performed for each cache management record in the embodiment.

FIG. 5 is a flowchart show an exemplary procedure of second save processing in the embodiment.

FIG. 6 is a view for explaining the second save processing.

FIG. 7 is a flowchart showing an exemplary procedure of first save processing in the embodiment.

FIG. 8 is a view for explaining the first save processing.

FIG. 9 is a flowchart showing an exemplary procedure of cache recovery processing in the embodiment.

### DETAILED DESCRIPTION

Various embodiments will be described hereinafter with reference to the accompanying drawings.

In general, according to one embodiment, a storage device includes a nonvolatile storage medium, a volatile memory and a controller. The nonvolatile storage medium includes a user data area. The volatile memory includes a cache area and a cache management area. The cache area is used to store, as write cache data, write data specified by a write command and to be written to the user data area. The cache management area is used to store management information associated with the write cache data and including a compression size for the write cache data. The compression size is calculated in accordance with reception of the write command. The controller executes save processing of compressing, based on the management information, write cache data which is not saved to a save area and is needed to be compressed, and writing the compressed write cache data to the save area.

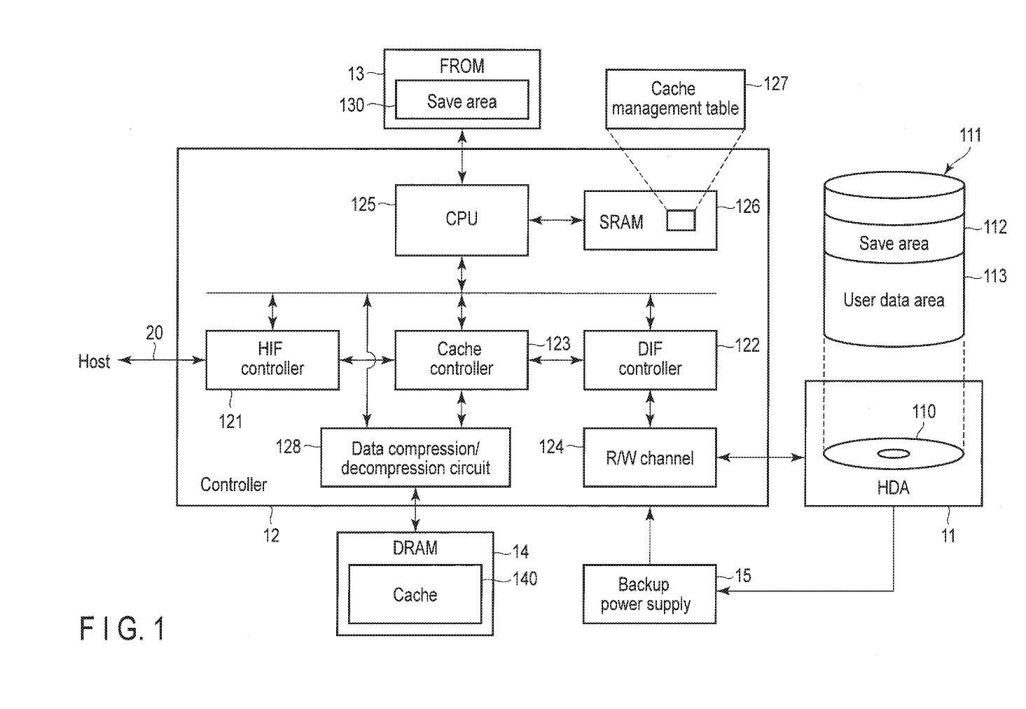

FIG. 1 is a block diagram showing an exemplary configuration of a magnetic disk device according to an embodiment. The magnetic disk device is a type of a storage device and is also called a hard disk drive (HDD). In the description below, the magnetic disk device will be referred to as the HDD. The HDD shown in FIG. 1 includes a head/disk assembly (HDA) 11, a controller 12, a flash ROM (FROM) 13, a dynamic RAM (DRAM) 14 and a backup power supply 15.

The HDA 11 includes a disk 110. The disk 110 is a nonvolatile storage medium having, for example, one surface that serves as a recording surface on which data is magnetically recorded. Namely, the disk 11 has a storage area 111. The HDA 11 further includes known elements, such as a spindle motor, an actuator, etc. However, these elements are not shown in FIG. 1.

The controller 12 is realized by, for example, a large-scale integrated circuit (LSI) called a system-on-a-chip (SOC) in which a plurality of elements are integrated on a single chip. The controller 12 includes a host interface controller (hereinafter, referred to as an HIF controller) 121, a disk interface controller (hereinafter, referred to as a DIF controller) 122, a cache controller 123, a read/write (R/W) channel 124, a CPU 125, a static RAM (SRAM) 126 and a data compression/decompression circuit 128.

The HIF controller 121 is connected to a host via a host interface 20. The HIF controller 121 receives commands (a write command, a read command, etc.) from the host. The HIF controller 121 controls data transfer between the host and the cache controller 123.

The DIF controller 122 controls data transfer between the cache controller 123 and the R/W channel 124. The cache controller 123 controls data transfer between the HIF controller 121 and the DRAM 14 and between the DIF controller 122 and the DRAM 14.

The R/W channel 124 processes signals associated with reading and writing. The R/W channel 124 converts a signal (read signal) read from the disk 110 into digital data using an analog-to-digital converter, and decodes the digital data into read data. Further, the R/W channel 124 extracts, from digital data, servo data needed for positioning a head. The R/W channel 124 encodes write data.

The CPU 125 functions as a main controller for the HDD shown in FIG. 1. The CPU 125 controls at least a part of the elements of the HDD in accordance with a control program. The at least part includes each of the controllers 121 to 123. In the embodiment, the control program is pre-stored in a specific region on the disk 11. However, the control program may be pre-stored in the FROM 13.

The SRAM 126 is volatile memory. A part of the storage area of the SRAM 126 is used as a cache management area for storing the cache management table 127. The data compression/decompression circuit 128 compresses and decompresses write cache data designated by the CPU 125. Supposing that write data is subjected to compression, the data compression/decompression circuit 128 calculates the size of the write data after compression. In place of the data compression/decompression circuit 128, a data compression machine and a data decompression machine may be used.

The FROM 13 is a rewritable nonvolatile memory. An initial program loader (IPL) is pre-stored in a part of the storage area of the FROM 13. The IPL may be pre-stored in a read-only nonvolatile memory, such as a ROM. The CPU 125 loads, to the SRAM 126 or the DRAM 14, at least a part of the control program stored on the disk 110 by, for example, executing the IPL after power is supplied to the HDD. Another part of the storage area of the FROM 13 is used as a save area (first save area) 130. The save area 130 is used as a save destination to which write cache data is saved based on a power loss protection function.

The DRAM 14 is a volatile memory lower in access speed than the SRAM 126. In the embodiment, the storage capacity of DRAM 14 is greater than that of the SRAM 126. A part of the storage area of the DRAM 14 is used as a cache (cache area) 140. The cache 140 is used for storing write data transferred from the host (namely, write data specified by a write command from the host) and read data read from the disk 110 as write cache data and read cache data.

Another part of the storage area of the DRAM 14 may be used for storing the cache management table 127. Similarly, another part of the storage area of the SRAM 126 may be used as the cache 140. Further, the storage areas of the DRAM 14 and the SRAM 126 can be regarded as parts of the storage area of one volatile memory.

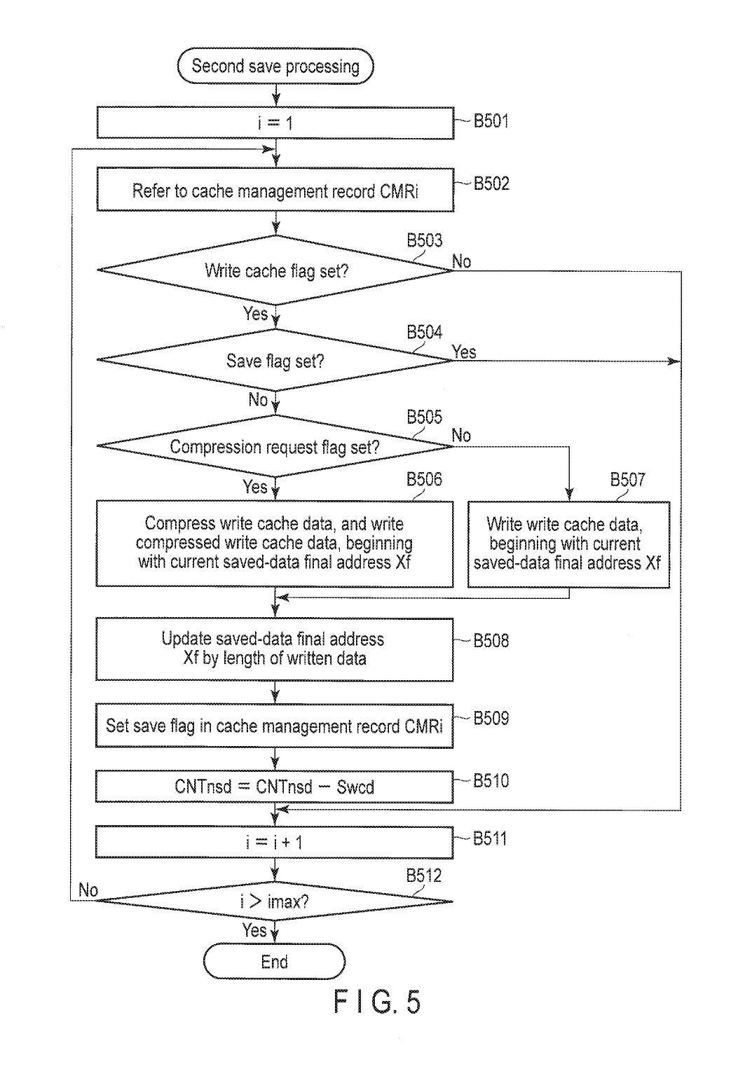

A part of the storage, area 111 of the disk 110 is used as a save area (a second save area) 112, and another part of the storage area 111 is used as a user data area 113. The save area 112 is, for example, a part of a system area that cannot be accessed by a user, and is used as a save destination to which write cache data is to be saved based on a media cache function. Assume that the start and end addresses of the save area 112 are X and Y, respectively (FIG. 6). Write cache data items are sequentially saved (written) to the save area 112, beginning with a portion of the save area 112 to which the leading address is allocated. In the embodiment, in order to manage the newest write start position of write cache data, a saved-data final address Xf is used. The saved-data final address Xf coincides with the leading address X of the save area 112 in an initial state. Whenever write cache data is written to the save area 112, beginning with the saved-data final address Xf, the saved-data final address Xf is incremented by the length of written data. Therefore, the saved-data final address Xf actually indicates an address subsequent to the final address that indicates an area. where write cache data is written last.

The user data area 113 is used for, for example, storing write data specified by a write command from. the host. An address (physical address), which indicates a physical position, in the user data area 113, where the write data is stored, is associated with a logical address (more specifically, a logical block address LBA) specified by the write command.

The backup power supply 15 generates power when, for example, the supply of power from the host to the HDD is interrupted. That is, the backup power supply 15 generates the power, used for maintaining a minimal operation of the HDD, in accordance with interruption (power interruption) of the supply of power to the HDD. The generated power is supplied, at least, to the controller 12 (more specifically, to the cache controller 123, the CPU 125, the SRAM 126 and the data compression/decompression circuit 128 in the controller 12), and to the FROM 13 and the DRAM 14.

In the embodiment, the power generated by the backup power supply 15 is used for, for example, retracting the head to a position (so-called a ramp position) separate from the disk 110. This power is also used for saving write cache data (more specifically, non-saved write cache data) from the cache 140 to the save area 130 in the FROM 13. For generation of the power, the backup power supply 15 uses the back electromotive force of the spindle motor (more specifically, the spindle motor for rotating the disk 110). Alternatively, the backup power supply 15 may generate the power, using a capacitor charged with a supply voltage applied to the HDD by the host.

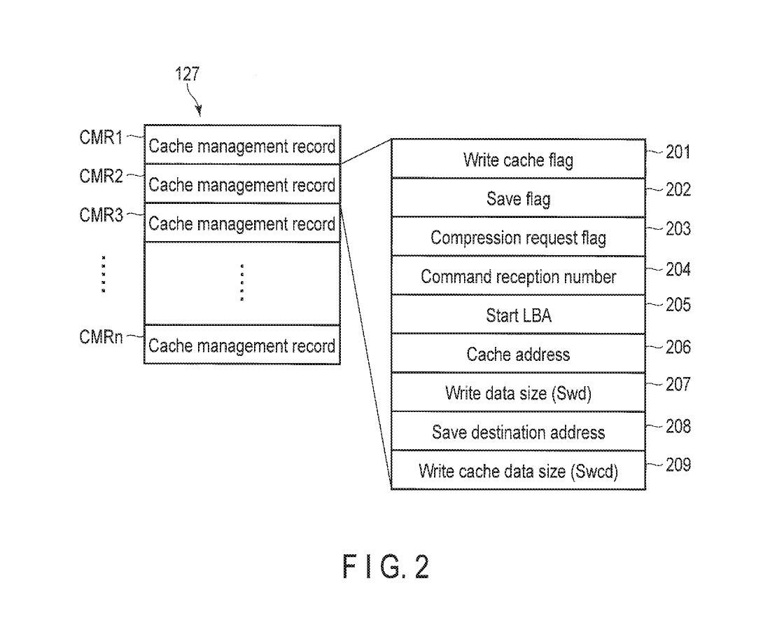

FIG. 2 shows a data structure example of the cache management table 127. The cache management table 127 is used for holding cache management records. In the example shown in FIG. 2, cache management records CMR1 to CMRn are held in n entries of the cache management table 127. For simplifying the description, assume that all cache management records CMR1 to CMRn are generated in accordance with write commands WCMD1 to WCMDn from the host. Namely, cache management records CMR1 to CMRn are assumed to be used for management of write cache data items WCD1 to WCDn stored in the cache 140, respectively. Cache management records CMR1 to CMRn have a certain length.

Each cache management record CHRi (i=1, 2, . . . , n) includes fields 201 to 209. Field 201 is used for holding a write cache flag (third flag). The write cache flag indicates whether cache management record CMRi (write cache data WCDi) is valid.

Field 202 is used for holding a save flag (second flag). The save flag indicates whether write cache data WCDi is already saved in the save area 112 of the disk 110. Field 203 is used for holding a compression request flag (first flag). When write cache data WCDi is saved to the save area 112 of the disk 110 or to the save area 130 of the FROM 13, the compression request flag indicates whether write cache data WCDi should be compressed.

Field 204 is used for holding a command reception number allocated to write command WCMDi. The command reception number is incremented in accordance with generation of a cache management record. Field 205 is used for holding a start LBA. The start LBA is included in write command WCMDi, and indicates the leading position of the logical range of write data WDi specified by write command WCMDi.

Field 206 is used for holding an address (namely, a cache address) in the cache 140, with which write data WDi is stored as write cache data WCDi. Field 207 is used for holding the size Swd of write data WDi (namely, write data size Swd).

Field 208 is used for holding the address (disk address or memory address) of the save destination of write cache data WCDi when write cache data WCDi is already saved in the save area 112 or 130. Field 209 is used for holding the size Swcd of write cache data WCDi (write cache data size Swcd). However, if the compression request flag is set in field 203, the write cache data size Swcd indicates the size (length) of write cache data WCDi obtained after compression, namely, indicates the size (compression size) of the compressed write cache data.

A description will now be given of the amount (hereinafter, referred to as the savable size Ss) of write cache data that can be saved from the cache 140 to the save area 130 of the FROM 13, using the backup power supply 15 during the power interruption. The size Ss is mainly determined by a period (namely, a backup possible period) T in which the backup power supply 15 can supply power, and the write speed v of the FROM 13. The backup possible period T is also a period (namely, a saving operation enabled period) in which write cache data can be saved from the cache 140 to the save area 130 of the FROM 13.

Supposing that the backup possible period T is 1 second and the write speed v of the FROM 13 is 1 MB (megabyte) per second, the savable size Ss is 1 MB. In this case, in order to secure write cache data in the cache 140 during the power interruption, it is necessary to always suppress, within 1 MB, the size (amount) of non-saved write cache data in the cache 140.

In view of the above, in the embodiment, the CPU 125 utilizes a counter (non-saved cache data counter) CNTnsd in order to monitor the amount of the non-saved write cache data in the cache 140. Counter CNTnsd is initially set to zero, and the size (write cache data size) Swcd of write cache data (write data) is added to the counter CNTnsd whenever the write cache data is stored (received) in the cache 140. Moreover, whenever write cache data is written to the save area 112 or the user data area 113 of the disk 110, its write cache data size Swcd is subtracted from the counter CNTnsd.

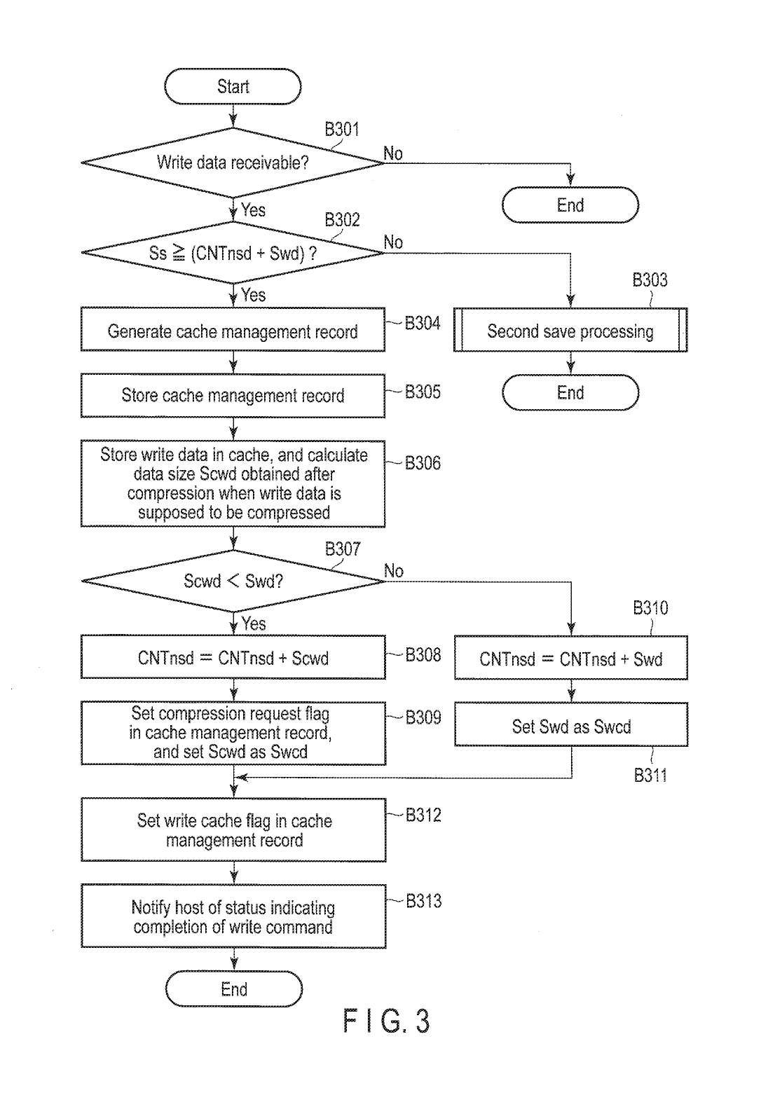

An operation in the embodiment will be described. Referring first to FIG. 3, write data reception processing will be described. FIG. 3 is a flowchart showing an exemplary procedure of write-data reception processing. The write-data reception processing is performed when the CPU 125 receives a write command from the host through the HIF controller 121. Further, the write-data reception processing is performed also when non-received write data exists.

Assume here that write command WCMDj is sent from the host to the HDD shown in FIG. 1 through the host interface 20. Write command WCMDj includes the start LBA indicating the leading position of a logical area in which write data specified by write command WCMDj is to be stored, and the size (write data size) Swd of the write data.

Write command WCMDj is received by the HIF controller 121. The received write command WCMD1 is transferred to the CPU 125. The CPU 125, in turn, performs write data reception processing in cooperation with the cache controller 123 and the data compression/decompression circuit 128, as described below.

First, the CPU 125 determines whether write data specified by received write command WCMDj can be received (B301). In the embodiment, if the cache 140 and the management table 127 have a free area and a free entry, respectively, it is determined that the specified write data can be received (Yes in B301).

In this case, the CPU 125 determines whether the sum (CNTnsd+Swd) of CNTnsd and Swd is not more than the savable size Ss, based on the savable size Ss, the value of the counter CNTnsd and the size Swd of the specified write data (B302). Namely, even if the CPU 125 receives the specified write data, it still determines whether the size of the non-saved cache data is not more than the savable size Ss.

If the determination in B302 is No, the CPU 125 does not accept the specified write data (more specifically, does not store the same in the cache 140). Next, the CPU 125 executes, using a media cache function, second save processing (B303) for saving, to the save area 112, all non-saved write cache data items currently stored in the cache 140. By the second save processing, the CPU 125 can newly accept (store), in the cache 140, write cache data of a size corresponding to the savable size Ss.

In contrast, if the determination in B302 is Yes, the CPU 125 determines that the size of non-saved write cache data in the cache 140 does not exceed the savable size Ss, even if the specified write data is stored in the cache 140. That is, the CPU 125 determines that all non-saved write cache data items in the cache 140 can be saved to the save area 130 of the FROM 13 within the backup possible period T, even if the power interruption occurs immediately after the specified write data is stored into the cache 140.

At this time, as pre-processing for storing the specified write data in the cache 140, the CPU 125 generates cache management record CMRj for managing the specified write data as write cache data (B304). Flags are not set in fields 201 to 203 of generated cache management record CMRj. The start LEA included in write command WCMDj is set in field 205 of cache management record CMRj. A cache address is set in field 206 of cache management record CMRj. This cache, address indicates the leading position of a free area in the cache 140, where the specified write data is to be stored. Further, in field 207 of cache management record CMRj, the size (namely, the real data size) of the specified write data is set as a write data size Swd. Fields 208 and 209 of cache management record CMRj are, for example, blank.

Next, the CPU 125 stores generated cache management record CMRj in a free entry of the cache management table 127 (B305). Next, the CPU 125 causes the cache controller 123 to store the specified write data in an area of the cache 140 designated by a cache address set in field 206 of cache management record CMRj (B306). In B306, the CPU 125 also causes the data compression/decompression circuit 128 to calculate the size (compression data size) Scwd of the specified write data obtained after compression when the specified write data is assumed to be compressed. Depending on the data pattern of the specified write data, the calculated size Scwd may not be smaller than the size Swd of the specified write data.

In view of this, the CPU 125 determines whether the calculated size Scwd is smaller than the size (namely, the real data size) Swd of the specified write data Swd (Scwd<Swd) (B307). If Scwd<Swd (Yes in B307), the CPU 125 executes B308 and B309 as described below, in order that compression processing for the specified write data will be performed when the write data is saved. First, in B308, the CPU 125 adds Scwd to the value of the counter CNTnsd. That is, the CPU 125 increments the counter CNTnsd by Scwd. In B309, the CPU 125 sets a compression request flag in. field 203 of cache management record CMRj stored in the cache management table 127. In B309, the CPU 125 further sets Scwd as the write cache data size Swcd in field 209 of cache management record CMR1. After that, the CPU 125 proceeds to B312.

In contrast, if Scwd<Swd is not satisfied (No in B307), the CPU 125 adds Swd to the value of the counter CNTnsd (B310). That is, the CPU 125 increments the counter CNTnsd by Swd. Next, the CPU 125 sets Swd as the write cache data size Swcd in field 209 of cache management record CMR1 stored in the cache management table 127 (B311). At this time, it should be noted that no compression request flag is set in field 209 of cache management record CMRj. Namely, cache management record CMRi maintains a state where the compression request flag is cleared. Thus, when specified write data is saved, compression processing targeted for this write data is suppressed. After executing B311, the CPU 125 proceeds to B312.

In B312, the CPU 125 sets a write cache flag in field 201 of cache management record CMRj in the cache management table 127. Next, the CPU 125 causes the HIF controller 121 to notify the host of a status that indicates the completion of write command WCMDj (B313). Thus, the CPU 125 finishes the write data reception processing. If the determination in B301 is No, the CPU 125 immediately finishes the write data reception processing. In this case, execution of write command WCMDj is postponed.

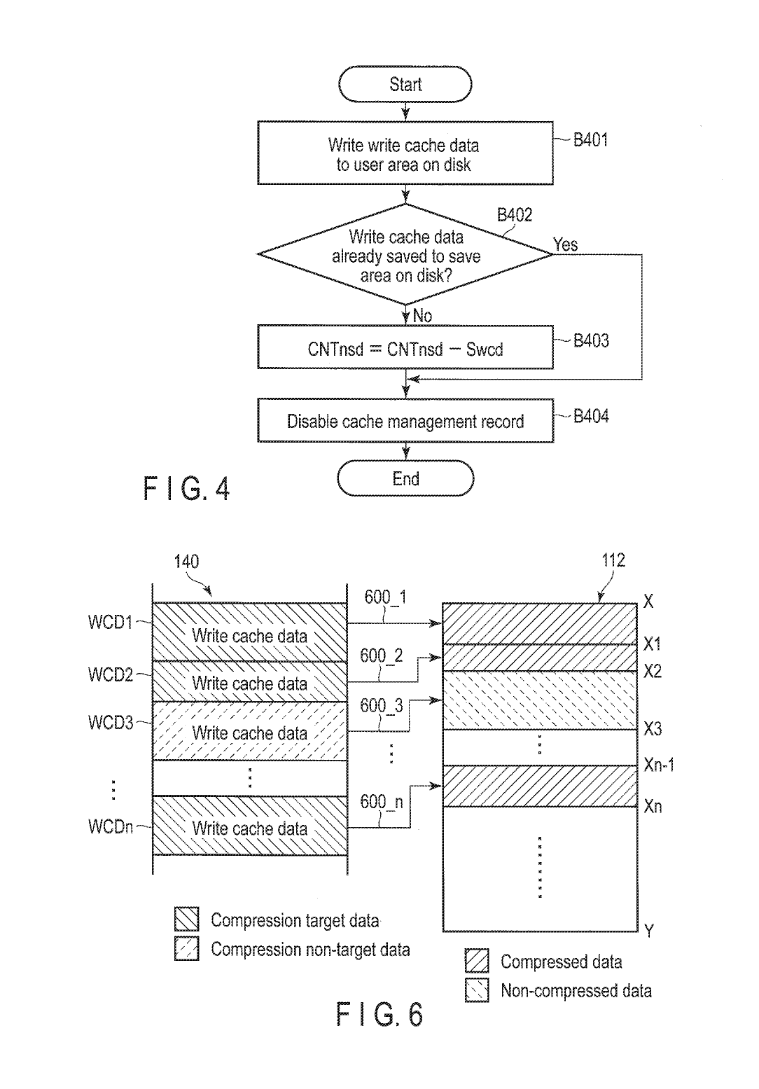

Referring then to FIG. 4, a description will be given of write-back processing in the embodiment. FIG. 4 is a flowchart showing an exemplary procedure of the write-back processing performed for each cache management record. The write-back processing is processing for writing write cache data, stored in the cache 140, to the user data area 113 of the disk 110.

For the write-back processing, the CPU 125, for example, selects cache management records from a group of cache management records in the cache management table 127, in which the write cache flags are set (namely, a group of valid cache management records), in an order in which write ranges indicated by the group of cache management records are optimally accessible. The group of cache management records corresponds to a group of write commands issued from the host. Therefore, the selection of cache management records is equivalent to the selection of write commands performed in an order in which write ranges indicated by a group of write commands corresponding to the group of valid cache management records are optimally accessible. The optimally accessible order means, for example, an order in which the time required for seek operations for switching the write ranges, and rotational latency are minimized.

The above-mentioned effect by cache management record selection is dependent on the number of valid cache management records in the cache management table 127. Accordingly, if the amount of write cache data stored in the cache 140 is limited, sufficient effect cannot be acquired. However, in the embodiment, the second save processing (B303 in FIG. 3) enables write cache data of an amount corresponding to the savable size Ss to be newly received in the cache 140. If the CPU 125 repeats the second save processing, write cache data of an amount corresponding to the memory size of the cache 140 can be received. Therefore, in the embodiment, the CPU 125 can execute write-back processing in an optimal order that enables the access time to be minimized.

Suppose here that for the write-back processing, the CPU 125 has selected cache management record CMRi from the cache management table 127. At this time, the CPU 125 writes, to the user data area 113 of the disk 110, write cache data WCDi in the cache 140 managed by cache management record CMRi (B401). The CPU 125 performs this operation (namely, the write-back operation) in cooperation with the cache controller 123 and the DIF controller 122. Further, for the write-back operation, the CPU 125 specifies a physical write range associated with a logical write range designated by the start LBA and the write data size Swd in cache management record CMRi, based on a well-known address mapping table. Write cache data WCDi is written to the specified write range in the user data area 113.

Next, the CPU 125 determines whether write cache data WCDi is already saved in the save area 112, based on whether the save flag is set in field 202 of cache management record CMRi (B402). If the determination in B402 is No, the CPU 125 subtracts, from the value of the counter CNTnsd, the write cache data size Swcd (=Scwd or Swd) set in field 209 of cache management record CMRi (B403). That is, the CPU 125 decrements the counter CNTnsd by Swcd. The reason this subtraction is performed is as follows:

As is evident from the above-described write-data reception processing, Swcd (=Scwd or Swd) is added to the value of the counter CNTnsd (B308 or B310 in FIG. 3) when cache management record CMR1 is stored in the cache management table 127 (B305 in FIG. 3). This addition is performed, supposing saving of write cache data WCDi to the save area 130 in the FROM 13 during the power interruption. However, when write cache data WCDi is written to the user data area 113 of the disk 110 as in the embodiment (B401), it is not necessary to save write cache data WCDi in the save area 130. In view of this, the above-mentioned subtraction (B403) is executed.

After executing B403, the CPU 125 proceeds to B404. In contrast, if the determination in B402 is Yes, the CPU 125 considers that subtraction corresponding to B403 is already executed, and skips B403 to thereby proceed to B404. In B404, the CPU 125 clears the write cache flag in cache management record CMRi stored in the cache management table 127, thereby disabling (or releasing) cache management record CMRi. After executing B404, the CPU 125 finishes the write-back processing. However, B404 does not always have to be performed, and cache management record CMRi may be disabled in accordance with a known least recently used (LRU) rule.

Referring then to FIG. 5, the second save processing (B303 in FIG. 3) included in the write-data reception processing shown in FIG. 3 will be described in detail. FIG. 5 is a flowchart show an exemplary procedure of the second save processing. As described above, the second save processing is performed when the size of non-saved cache data reaches the savable size Ss in the write-data reception processing shown by the flowchart of FIG. 3 (No in B302).

First, the CPU 125 sets, to an initial value of 1, an entry pointer i that indicates an entry in the cache management table 127, in order to refer to the cache management records in the cache management table 127 in order (B501). Next, the CPU 125 refers to cache management record CMRi stored in an i^{th} entry in the cache management table 127 indicated by the entry pointer i (B502).

Next, the CPU 125 determines whether the write cache flag is set in cache management record CMRi (B503). If the write cache flag is set (Yes in B503), the CPU 125 determines whether the save flag is set in cache management record CMRi (B504). If the save flag is not set (NO in B504), the CPU 125 determines whether the compression request flag is set in cache management record CMRi (B505).

If the compression request flag is set (Yes in B505), the CPU 125 proceeds to B506. In contrast, if the compression request flag is not set (No in B505), the CPU 125 proceeds to B507.

In B506, the CPU 125 executes a saving operation for compressing write cache data WCDi managed by cache management record CMRd, and for writing (saving) the compressed write cache data to the save area 112, as follows: First, the CPU 125 requests the cache controller 123 to read write cache data WCDi managed by cache management record CMRi, and requests the data compression/decompression circuit 128 to compress read write cache data WCDi.

At this time, the cache controller 123 reads write cache data WCDi from an area of the cache 140 specified by a cache address and a write data size Swd in cache management record CMRi. Read write cache data WCDi is Input to the data compression/decompression circuit 128. The data compression/decompression circuit 128 compresses input write cache data WCDi. Compressed write cache data WCDi is transmitted to the DIF controller 122 through the cache controller 123. The CPU 125 requests the DIF controller 122 to write compressed write cache data WCDi to the save area 112, beginning with the saved-data final address Xf. The DIF controller 122 executes the requested write. The CPU 125 sets the saved-data final address Xf as a save destination address in field 208 of cache management record CMRi in the cache management table 127.

In contrast, in B507, the CPU 125 executes a saving operation for writing write cache data WCDi to the save area 112 without compression, as follows: First, the CPU 125 requests the cache controller 123 to read write cache data WCDi. It should be noted that at this time, the CPU 125 does not request the data compression/decompression circuit 128 to compress read write cache data WCDi.

In response to the request from the CPU 125, the cache controller 123 reads write cache data WCDi from the cache 140. Read write cache data WCDi is transferred to the DIF controller 122 through the data compression/decompression circuit 128 and the cache controller 123. The CPU 125 requests the DIF controller 122 to write read write cache data WCDi (namely, uncompressed write cache data WCDi) to the save area 112, beginning with the saved-data final address Xf. The DIF controller 122 performs the requested write. The CPU 125 sets the saved-data final address Xf as a save destination address in field 208 of cache management record CMRi in the cache management table 127.

After executing B506 or B507, the CPU 125 updates (more specifically, increments) the saved-data final address Xf by the length of data written in B506 or B507 (B508). Next, the CPU 125 sets the save flag in field 202 of cache management record CRi in accordance with the above-mentioned saving operation (B509). Next, the CPU 125 subtracts, from the value of the counter CNTnsd, the write cache data size Swcd (=Scwd or Swd) set in cache management record CMRi, in accordance with the saving operation (B510). B510 may be executed before B509.

After executing B509 and B510, the CPU 125 proceeds to B511. In contrast, if the write cache flag is not set in cache management record CMRi (No in B503), the CPU 125 determines that write cache data WCDi is written in the user data area 113 of the disk 110. In this case, since it is not necessary to save write cache data WCDi, the CPU 125 skips B505 to B510 and proceeds to B511. Also when the save flag is set in cache management record CMPi (Yes in B504), the CPU 125 skips B504 to B510 and proceeds to B511.

In B511, the CPU 125 increments the entry pointer i by one. After that, the CPU 123 determines whether the incremented entry pointer i exceeds imax (in FIG. 2, imax=n) that indicates a final entry in the cache management table 127 (B512). If the incremented entry pointer i does not exceed imax (No in B512), the CPU 125 returns to B502. Thus, the CPU 125 repeats a series of processes, beginning with B502, for each of cache management records CMR1 to CMRn in the cache management table 127. When the incremented entry pointer i exceeds imax (Yes in B512), the CPU 125 finishes the second save processing.

FIG. 6 is a view for explaining the above-mentioned second save processing. As shown in FIG. 6, write cache data items WCD1 to WCDn are stored in the cache 140. Write cache data WCDi (i=1, 2, . . . , n) is managed by cache management record CMRi stored in the cache management table 127 shown in FIG. 2. For simplifying the description, assume that none of write cache data items WCD1 to WCDn is written to the disk 110 when the second save processing is started. Assume also that in FIG. 6, for example, write cache data items WCD1, WCD2 and WCDn included in write cache data items WCD1 to WCDn are data items (compression target data items) requested to be compressed, and write cache data item WCD3 is a data item (compression non-target data item) that is not requested to be compressed.

In this case, first, write cache data WCD1 is read and compressed, and the resultant compressed write cache data WCD1 is written (saved) to an area of the save area 112 that begins with the leading address X, as indicated by arrow 600_1. In accordance with this writing, the saved-data final address Xf is updated from X to X1.

Next, write cache data WCD2 is read and compressed, and the resultant compressed write cache data WCD2 is written to an area of the save area 112 that begins with address X1 (Xf=X1), as indicated by arrow 600_2. In accordance with this writing, the saved-data final address Xf is updated from X1 to X2.

Next, write cache data WCD3 is read, and is written, without compression, to an area of the save area 112 that begins with address X2 (Xf=X2), as indicated by arrow 600_3. In accordance with this writing, the saved-data final address Xf is updated from X2 to X3.

Similarly, subsequent write cache data items are read, compressed and written to, or read and written without compression to the save area 112. Last, write cache data WCDn is read and compressed, and the resultant compressed write cache data WCDn is written to an area of the save area 112 that begins with address Xn−1 (Xf=Xn−1), as indicated by arrow 600_n. In accordance with this writing, the saved-data final address Xf is updated from Xn−1 to Xn.

Thus, in the embodiment, at least part of write cache data items WCD1 to WCDn are compressed and then written to the save area 112. As a result, the period required for writing to the save area 112 is shortened, compared to a case where all write cache data items WCD1 to WC are written without compression. Assuming that the average compressibility of write cache data items WCD1 to WCDn is 20%, the period required for writing to the save area 112 is shortened by 20%, compared to a case where all write cache data items WCD1 to WCDn are written without compression. Moreover, in the embodiment, write cache data items WCD1 to WCDn are sequentially written (after or without compression) to the save area 112. This further shortens the period required for writing to the save area 112.

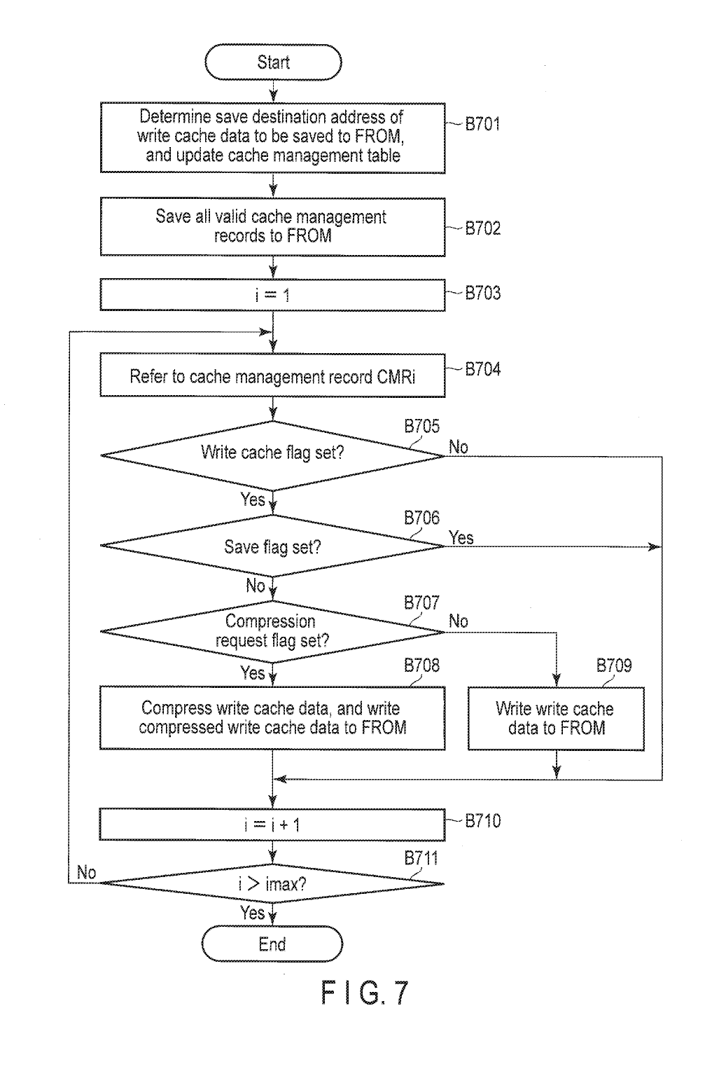

Referring then to FIG. 7, a description will be given of first save processing, performed in the embodiment during the power interruption, of saving non-saved write cache data stored in the cache 140 to the save area 130 of the FROM 13. FIG. 7 is a flowchart showing an exemplary procedure of the first save processing.

Assume here that the CPU 125 has detected, for example, interruption of the supply of power from the host to the HDD. In this case, the CPU 125 performs the second save processing shown by the flowchart of FIG. 7, using a power loss protection function.

In B701, first, the CPU 125 sequentially refers to all cache management records stored in the cache management table 127, thereby specifying cache management records that manage write cache data to be saved to the save area 130 of the FROM 13. Specifically, the CPU 125 specifies cache management records (cache management records in a first state) where the write cache flags are set and the save flags are cleared. At this time, the CPU 125 also specifies cache management records where only the write cache flags are set, i.e., valid cache management records (cache management records in a second state). Write cache data items managed by the cache management records in the second state are not saved to the save area 112 of the disk 110 or to the save area 130 of the FROM 13. The write cache data items managed by the cache management records in the second state are not written to the user area 111 of the disk 110. The group of cache management records in the first state is included in the group of cache management records in the second state.

In the embodiment, the group of (valid) cache management records in the second state is written to the save area 130, beginning with the leading position thereof. Then, all write cache data items managed by the cache management records in the first state are written to the save area 130, after or without compression, so that they will follow the cache management records in the second state.

For realizing the above writing, the CPU 125 determines the save destination addresses of the write cache data items to be saved based on the cache management records in the first and second states. The save destination addresses are determined based on the data size of the group of cache management records in the first state, and write cache data size Swcd set in field 207 of each of the cache management records in the second state. The data size of the group of cache management records in the first state is determined based on the number of the cache management records in the first state.

Next, the CPU 125 updates the cache management records in the second state, which are stored in the cache management table 127, based on the save destination addresses. That is, the CPU 125 sets the determined save destination addresses in fields 208 of respective cache management records in the second state. Thus, the CPU 125 finishes the execution of B701.

Next, the CPU 125 writes, as cache management information, the group of cache management records in the second state (namely, valid cache management records), beginning with the leading position of the save area 130 (B702). After that, the CPU 125 executes B703 to B711, which correspond to B501 to B507, B511, and B512 in the second save processing shown by the flowchart of FIG. 5, as will be described below.

First, the CPU 125 sets the pointer i to an initial value of 1 (B703). Next, the CPU 125 refers to cache management record CMRi stored in the i^{th} entry of the cache management table 127, which is indicated by the entry pointer i (B704).

If in cache management record CMRi, the write cache flag and the compression request flag are set, and the save flag is not set (Yes in B705, No in B706 and Yes in B707), the CPU 125 executes B708 in cooperation with the cache controller 123 and the data compression/decompression circuit 128. In B708, the CPU 125 compresses write cache data WCDi managed by cache management record CMRi, and writes (saves) the compressed write cache data to the save area 130, beginning with a position designated by a save destination address in cache management record CMRi. After executing B708, the CPU 125 proceeds to B710.

In contrast, if in cache management record CMRi, the write cache flag is set and the compression request flag is not set (Yes in B705, No in B706 and No in B707), the CPU 125 executes B709 in cooperation with the cache controller 123. In B709, the CPU 125 writes write cache data WCDi, without compression, to the save area 130, beginning with a position designated by a save destination address in cache management record CMRi.

After executing B709, the CPU 125 proceeds to B710. Further, if in cache management record CMRi, the write cache flag is not set (No in B705), the CPU 125 skips B706 to B709, and proceeds to B710. Furthermore, if in cache management record CMRi, the write cache flag is set and the save flag is also set (Yes in B705 and Yes in B706), the CPU 125 also proceeds to B710.

In B710, the CPU 125 increments the entry pointer i by one. Next, the CPU 125 determines whether the incremented entry pointer i exceeds imax (=n) (B711). If the incremented entry pointer i does not exceed imax (No in B711), the CPU 125 returns to B704. The CPU 125 repeats a series of processes mentioned above, beginning with B704, for all cache management records CMR1 to CMRn in the cache management table 127.

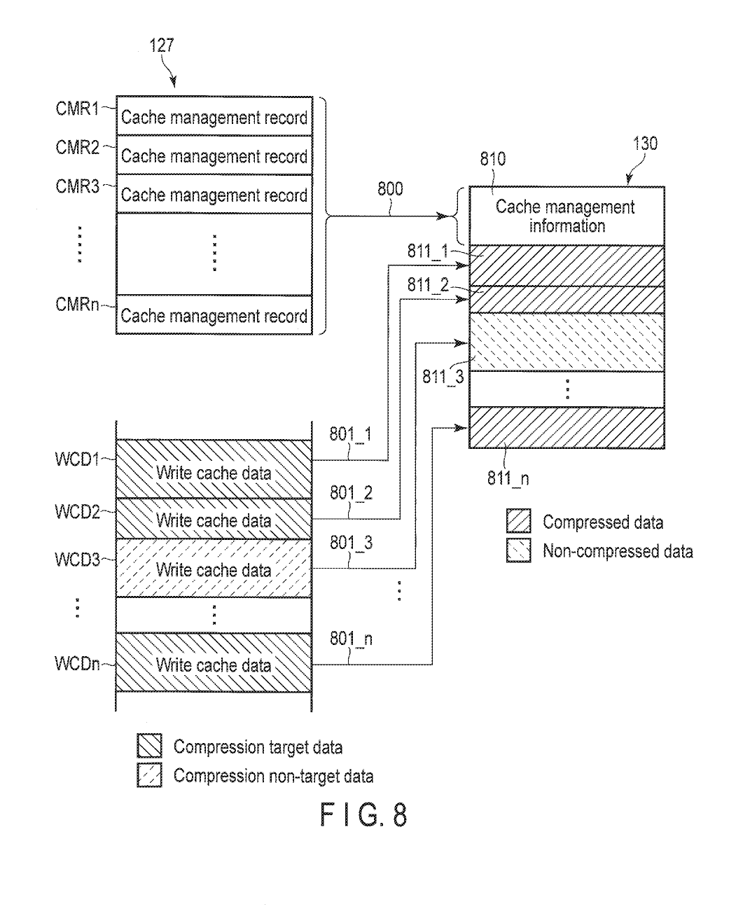

FIG. 8 is a view for explaining the first save processing. As shown in FIG. 8, cache management records CMR1 to CMRn are stored in the cache management table 127. For simplifying the description, assume that all cache management records CMR1 to CMRn are in the first and second states. Assume also that in FIG. 8, write cache data items WCD1, WCD2 and WCDn included in write cache data items WCD1 to WCDn are data items (compression target data items) requested to be compressed, and write cache data item WCD3 is a data item (compression non-target data item) that is not requested to be compressed.

In this case, first, the group of cache management records CMR1 to CMRn is written as cache management information to a write range 810 in the save area 130, which begins with the leading address of the area 130, as indicated by arrow 800. Namely, cache management records CMR1 to CMRn are written to the write range 810 in this order. The size of the write range 810 is equal to that of all cache management records CMR1 to CMRn.

Next, write cache data WCD1 is read and compressed, and is written to write range 811_1 that follows write range 810, as indicated by arrow 801_1. The size of write range 811_1 is equal to that of compressed write cache data WCD1, and the leading address of write range 811_1 is designated by a save destination address in cache management record CMR1.

Next, write cache data WON is read and compressed, and is written to write range 811_2 that follows write range 811_1, as indicated by arrow 801_2. The size of write range 811_2 is equal to that of compressed write cache data WCD2, and the leading address of write range 811_2 is designated by a save destination address in cache management record CMR2.

Next, write cache data WCD3 is read, and is written, without compression, to write range 811_3 that follows write range 811_2, as indicated by arrow 801_3. The size of write range 811_3 is equal to that of write cache data WCD3, and the leading address of write range 811_3 is designated by a save destination address in cache management record CMR3.

Similarly, subsequent write cache data items are read and written to a write range subsequent to the write range 811_2, after or without compression. Last, write cache data WCDn is read and compressed, and is written to write, range 811_n in the save area 130, as indicated by arrow 801_n. The size of the write range 811_n is equal to that of compressed write cache data WCDn, and the leading address of the write range 811_n is designated by a save destination address in cache management record CMRn.

Thus, in the first save processing in the embodiment, write cache data, whose data amount is to be reduced by compression processing and hence which has a smaller data size than the original one, is written to the save area 130 of the FROM 13 after compression. As a result, during the power interruption, the amount of write cache data to be saved to the FROM 13 can be reduced, and hence the period required for saving (writing), to the FROM 13, non-saved write cache data to the disk 110 can be shortened. Moreover, the amount of the write cache data that can be saved to the FROM 13 during the backup possible period T of the backup power supply 15 can be increased. That is, the amount (namely, the savable size Ss) of write cache data that can be stored in the cache 140 can be increased, which enhances write cache performance.

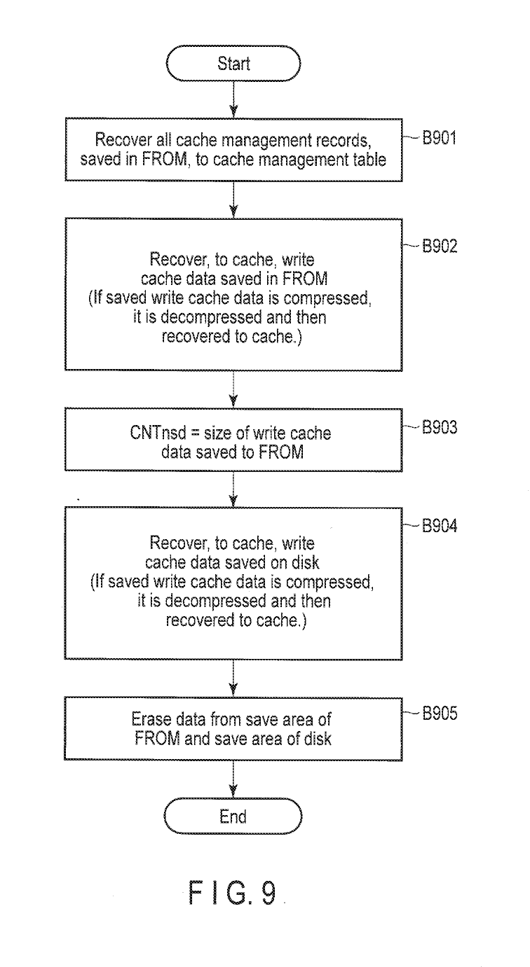

Referring then to FIG. 9, a description will be given of cache recovery processing in the embodiment for recovering, to the cache management table 127 and the cache 140, cache management records and write cache data saved in the save area 130 of the FROM 13, respectively. FIG. 9 is a flowchart showing an exemplary procedure of cache recovery processing in the embodiment. The cache recovery processing is performed when the supply of power from outside to the HDD is resumed.

First, the CPU 125 recovers, to the cache management table 127, cache management information items stored in the save area 130 of the FROM 13, i.e., a group of cache management records in the second state (B901). At this time, assume that the save area 130 is in a state as shown in FIG. 8. In this case, by the execution of B901, cache management records CMR1 to CMRn are recovered to the cache management table 127 in this order.

Next, in cooperation with the cache controller 123, the CPU 125 recovers, to the cache 140, write cache data items saved in the save area 130 (B902). However, if the saved write cache data items are compressed, the CPU 125 requests the data compression/decompression circuit 128 to decompress the compressed write cache data items. The CPU 125 can determine whether the saved write cache data items are compressed, based on whether the compression request flag is set in each of the cache management records for managing the write cache data items.

The data compression/decompression circuit 128 decompresses the write cache data items input thereto from the CPU 125 through the cache controller 123, in accordance with a decompression request from the CPU 125. As a result, the decompressed write cache data items are recovered to the cache 140. If there is no request for decomposition from the CPU 125, the write cache data items input to the data compression/decompression circuit 128 are transferred, without decompression, to the DRAM 14. Thus, the data items are saved to the cache 140.

Next, the CPU 125 sets, in the counter CNTnsd, the total size of the write cache data items saved to the save area 130 of the FROM 13 (B903). In the embodiment, the total size of write cache data items WCD1 to WCDn is set in the counter CNTnsd.

Next, if there is write cache data saved to the save area 112 of the disk 110, the CPU 125 recovers it to the cache 140 in cooperation with the DIF controller 122 and the cache controller 123 (B904). If write cache data saved in the save area 112 is compressed, the CPU 125 requests the data compression/decompression circuit 128 to decompress the compressed write cache data. The CPU 125 can determine whether saved write cache data is compressed, based on whether a compression request flag is set in a cache management record managing the write cache data.

In response to the decompression request from the CPU 125, the data compression/decompression circuit 128 decompresses write cache data supplied thereto from the CPU 123 through the cache controller 123. As a result, the decompressed write cache data is recovered to the cache 140. If there is no decompression request from the CPU 125, write cache data input to the data compression/decompression circuit 128 is transferred to the DRAM 14 and recovered to the cache 140 without decompression. Last, the CPU 125 erases data from the save area 130 of the FROM 13 and from the save area 112 of the disk 110 (B905), thereby finishing the cache recovery processing.

In the embodiment, the period required for save processing can be shortened by compressing write cache data and saving the compressed write cache data. This enables the amount of write cache data, which can be saved within a backup possible period T, to be increased in save processing (first save processing) using the power loss protection function. As a result, the savable size Ss can be increased. Further, in save processing (first save processing) using the media cache function, the period required for saving write cache data to the save area 112 of the disk 110 can be shortened. This advantage is equivalent to shortening the period required for processing write commands.

In the embodiment, the CPU 125 determines whether whole write data (write cache data) specified by a write command from the host should be compressed. However, the CPU 125 may determine logical-block by logical-block, instead of the whole write data, whether write data should be compressed, each logical block constituting: a part of the write data and having a certain size (for example, 512 bytes). The logical block is a minimum unit of access to the HDD by the host.

In the embodiment, the CPU 125 has the power loss protection function and the media cache function, and performs the first and second save processings. However, the CPU 125 may only have either the power loss protection function or the media cache function, and performs only a corresponding one of the first and second save processings.

In particular, if the savable size Ss is greater than that of the embodiment, for instance, if it is substantially the same as the size of the cache 140, the media cache function (second save processing) is not always necessary. Such a state can be realized when, for example, the backup power supply 15 has a structure for generating power using a capacitor charged with a power supply voltage applied to the HDD by the host. This is because in this case, the backup possible period T can be sufficiently increased, compared to the embodiment.

Similarly, if the savable size Ss is smaller than that of the embodiment, for instance, if it is less than several hundred KB (kilobytes), all processings in the power loss protection function (first save processing) are not always necessary. In this case, it is sufficient if the CPU 125 saves only a group of valid cache management records to the save area 130 of the FROM 13, and if the CPU 125 causes the HIF controller 121 to notify the host of a status indicating the completion of a write command corresponding to write cache data when the write cache data has been written to the save area 112 of the disk 110.

In the embodiment, it is assumed that the storage device is a magnetic disk device. However, the storage device may be a semiconductor drive unit, such as an SSD, which has a nonvolatile memory medium including a group of nonvolatile memories (such as NAND memories).

According to at least one embodiment described above, the period required for saving write cache data can be shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a nonvolatile storage medium including a user data area;
a volatile memory including a cache area and a cache management area, the cache area being used to store, as write cache data, write data specified by a write command and to be written to the user data area, the cache management area being used to store management information associated with the write cache data and including a compression size for the write cache data, the compression size being calculated in accordance with reception of the write command; and
a controller configured to execute save processing of compressing, based on the management information, non-saved write cache data which is not saved to a save area and is needed to be compressed, and writing the compressed write cache data to the save area.

2. The storage device of claim 1, further comprising a nonvolatile memory including a first save area used as the save area,
wherein the controller is configured to execute the save processing in accordance with interruption of supply of power to the storage device.

3. The storage device of claim 2, wherein the controller is further configured to execute first recovery processing of recovering, to the cache area, write cache data written in the first save area, in. accordance with resumption of the supply of power to the storage device, the first recovery processing including decompressing the write cache data to be recovered, when the write cache data to be recovered is compressed.

4. The storage device of claim 2, further comprising a backup power supply configured to supply power, used at least for the save processing, in accordance with the interruption of the supply of power,
wherein the controller is further configured to suppress an amount of the non-saved write cache data within a savable size, the savable size indicating an amount of data writable to the first save area in a period in which power is supplied from the backup power supply.

5. The storage device of claim 4, wherein:
the nonvolatile storage medium further includes a second save area; and
the controller is further configured to:
determine whether an amount of non-saved write cache data including write data specified by the received write command is not more than the savable size, even if the specified write data is stored as the write cache data in the cache area; and
store the specified write data as write cache data to the cache area, or execute processing of compressing and writing, in accordance with a result of the determination, wherein the processing of compressing and writing includes compressing non-saved write cache data in the cache area before storing the specified write data in the cache area, and then writing the compressed write cache data to the second save area.

6. The storage device of claim 5, wherein the controller is further configured to execute the determination by comparing, with the savable size, a sum of the amount of the non-saved write cache data in the cache area and a size of the specified write data.

7. The storage device of claim 5, wherein the controller is further configured to:
calculate a size of write data obtained after compression, assuming that the specified write data is subjected to the compression, when the specified write data is stored as the write cache data in the cache area in accordance with a result or the determination; and
calculate, based on a result of the calculation, an amount of the non-saved write cache data in the cache area, obtained after the specified write data is stored in the cache area.

8. The storage device of claim 5, wherein the controller is further configured to:
calculate a size of write data obtained after compression, assuming that the specified write data is subjected to the compression, when the specified write data is stored as the write cache data in the cache area in accordance with a result of the determination;
add the calculated size to an amount of the non-saved write cache data in the cache area, obtained before the specified write data is stored in the cache area, in a first case where the calculated size is shorter than a size of the specified write data; and
add the size of the specified write data to the amount of the non-saved write cache data in the cache area, obtained before the specified write data is stored in the cache area, in a second case where the calculated size is not shorter than the size of the specified write data.

9. The storage device of claim 8, wherein the controller is further configured to:
set, in the first case, a first flag in management information associated with write cache data stored in the cache area in accordance with the received write command, the first flag indicating that compression processing is necessary; and
compress non-saved write cache data in the cache area, which is indicated by the management information, and is to be written to the first or second save area, based on whether the first flag is set in the management information, when the non-saved write cache data is written to the first or second save area.

10. The storage device of claim 9, wherein the controller is further configured to:
set a second flag in the management information when the non-saved write cache data indicated by the management information is written to the second save area after compression or without compression, the second flag indicating an already saved state; and
subtract, in accordance with writing data to the second save area, a size of the data written to the second save area from an amount of non-saved write cache data in the cache area, obtained before the data is written to the second save area.

11. The storage device of claim 9, wherein:
the save processing includes writing, to the first save area, all valid management information stored in the cache management area in accordance with the interruption of the supply of power; and
the controller is further configured to:
recover, to the cache management area, management information written in the first save area in accordance with resumption of the supply of power to the storage device;
execute first recovery processing of recovering, to the cache area, write cache data written in the first save area, the first recovery processing including decompression of the write cache data to be recovered, when the first flag is set in management information corresponding to the write cache data to be recovered; and
execute second recovery processing of recovering, to the cache area, write cache data written in the second save area, the second recovery processing including decompression of the write cache data to be recovered, when the first flag is set in management information corresponding to the write cache data to be recovered

12. The storage device of claim 5, wherein the controller is further configured to:
count, using a counter, an amount of non-saved write cache data in the cache area; and
execute the determination by comparing, with the savable size, a sum or a value of the counter and a size of the specified write data.

13. The storage device of claim 1, wherein:
the nonvolatile storage medium further includes the save area; and
the controller is configured to execute the save processing based on an amount of the non-saved write cache data, when a write command is newly received.

14. A method in a storage device comprising a nonvolatile storage medium and a volatile memory, the nonvolatile storage medium including a user data area, the volatile memory including a cache area and a cache management area, the cache area being used to store, as write cache data, write data specified by a write command and to be written to the user data area, the cache management area being used to store management information associated with the write cache data and including a compression size for the write cache data, the compression size being calculated in accordance with reception of the write command, the method comprising:
compressing, based on the management information, non-saved write cache data which is not saved to a save area and is needed to be compressed; and
writing the compressed write cache data to the save area.

15. The method of claim 14, wherein:
the storage device further comprises a nonvolatile memory including a first save area used as the save area; and
compressing the non-saved write cache data and writing the compressed write cache data are executed in accordance with interruption of supply of power to the storage device.

16. The method of claim 15, further comprising executing first recovery processing of recovering, to the cache area, write cache data written in the first save area, in accordance with resumption of the supply of power to the storage device, the first recovery processing including decompressing the write cache data to be recovered, when the write cache data to be recovered is compressed.

17. The method of claim 15, wherein:
the storage device further comprises a backup power supply configured to supply power, in accordance with the interruption of the supply of power, used at least for compressing the non-saved write cache data and writing the compressed write cache data; and
the method further comprises suppressing an amount of the non-saved write cache data within a savable size, the savable size indicating an amount of data writable to the first save area in a period in which power is supplied from the backup power supply.

18. The method of claim 17, wherein:
the nonvolatile storage medium further includes a second save area; and
the method further comprises:
determining whether an amount of non-saved write cache data including write data specified by the received write command is not more than the savable size, even if the specified write data is stored as the write cache data in the cache area; and
storing the specified write data as write cache data to the cache area, or executing processing of compressing and writing, in accordance with a result of the determination, wherein the processing of compressing and writing includes compressing non-saved write cache data in the cache area before storing the specified write data in the cache area, and then writing the compressed write cache data to the second save area.

19. The method of claim 18, further comprising comparing, with the savable size, a sum of the amount of the non-saved write cache data in the cache area and a size of the specified write data.

20. The method of claim 14, wherein:
the nonvolatile storage medium further includes the save area; and
compressing the non-saved write cache data and writing the compressed write cache data are executed based on an amount of the non-saved write cache data, when a write command is newly received.
